(19) United States
(12) Patent Application Publication
(10) Pub. No.: US 2026/0253820 A1
(43) Pub. Date: Aug. 27, 2026

(54) Rotary Switch for Vehicle

(71) Applicant: Jet Optoelectronics Co., Ltd., Taipei City (TW)

(72) Inventors: Wei-Kuo Chiu, Taipei City (TW); Wen-Ta Lee, Taipei City (TW)

(21) Appl. No.: 19/326,370

(22) Filed: Sep. 11, 2025

(30) Foreign Application Priority Data
Feb. 26, 2025 (CN) 202510217934.9

(51) Int. Cl. H01H 19/14; H01H 19/04

(52) U.S. Cl. CPC H01H 19/14; H01H 19/04

(57) ABSTRACT

The present disclosure provides a rotary switch for vehicle, comprising: a switch body, a conductive member and a rotating member. The switch body is provided with an arc portion on an outer surface of the switch body; the conductive member is attached to the arc portion and is disposed on the outer surface of the switch body; the conductive member is electrically connected to a control module, and the conductive member is provided with a plurality of conductive areas spaced apart along a circumferential direction of the arc portion. The rotating member is rotatably arranged outside the switch body; the rotating member is provided with a conductive part corresponding to the plurality of conductive areas, so that when the rotating member is rotated, the conductive part conducts one of the plurality of conductive areas. The present disclosure can reduce the usage of push switches through the above configuration, thereby reducing the volume and cost of components.

### CROSS-REFERENCE TO RELATED APPLICATION

This application claims the benefit of Chinese Patent Application No. 2025102179349, filed on Feb. 26, 2025, in the National Intellectual Property Administration of the People's Republic of China, the disclosure of which is incorporated herein in its entirety by reference.

### BACKGROUND OF THE INVENTION

### 1. Field of the Invention

The present disclosure relates to the technical field of switches, and in particular to a multi-stage rotary switch for vehicle.

### 2. Description of the Related Art

The wiper control system on general vehicles is a multi-stage control system. Therefore, the user can adjust the oscillation frequency of the wipers of the front windshield or rear windshield according to the intensity of rain by toggling or rotating the wiper switch so that the oscillation frequency of the wipers can appropriately correspond to the current rain intensity.

Referring to the following FIGS. 1 and 2. Currently, the mechanism of the rotary switch of the wiper lever is mostly a cylindrical circuit board bracket 11 and a push switch 13 on a hard electronic circuit board 12. The triggering method is that when the sleeve 14 is rotated, the internal step structure pushes the circular structure column 15 and triggers the push switch 13. When multi-stage rotation is actuated, each stage corresponds to a push switch, which means that the multi-stage switch needs to correspond to multiple push switches, which increase the number of parts and cost. Therefore, the need to reduce the number of parts and cost while realizing the function of the rotary switch of the wiper lever has become a technical problem that needs to be solved.

In summary, the inventor of the present disclosure has considered and designed a rotary switch for vehicle in order to improve the deficiencies of the prior art and further promote its industrial implementation and utilization.

### SUMMARY OF THE INVENTION

The primary objective of the present disclosure is to provide a rotary switch for vehicle to solve the above-mentioned problem.

To achieve the foregoing objective, the present disclosure provides a rotary switch for vehicle, comprising: a switch body, a conductive member and a rotating member. An arc portion is provided on the outer surface of the switch body. The conductive member is attached to the arc portion and arranged on the outer surface of the switch body. The conductive member is electrically connected to a control module, and the conductive member is provided with a plurality of conductive areas spaced apart along the circumferential direction of the arc portion. The rotating member is rotatably arranged outside the switch body. The rotating member is provided with a conductive part corresponding to the plurality of conductive areas, so that when the rotating member is rotated, the conductive part conducts one of the plurality of conductive areas.

Preferably, the rotating member is provided with an extension arm extending toward the conductive member; and the conductive portion is disposed at an end of the extension arm away from the rotating member.

Preferably, the conductive portion is a metal sleeve sleeved on an end of the extension arm.

Preferably, the arc portion is a semicircular arc.

Preferably, a lip is provided on the outer surface of the switch body, the lip is closer to the rotating member than the conductive member; the rotating member is provided with two hooking portions facing each other and corresponding to the lip; when the rotating member is assembled to the switch body, the hooking portions are hooked to the lip.

Preferably, an inner surface of the rotating member is provided with at least one wave portion; the outer surface of the switch body is provided with at least one elastic protrusion corresponding to the wave portion; when the rotating member is assembled to the switch body, the elastic protrusion is embedded in one of a groove of the wave portion.

The technical features of the present disclosure will be described in detail below with specific embodiments and accompanying drawings so that those skilled in the art can easily understand the objectives, technical features, and advantages of the present disclosure.

### BRIEF DESCRIPTION OF THE DRAWINGS

In order to clearly illustrate the technical solutions of the embodiments of the present disclosure, the accompanying drawings used in describing the embodiments of the present disclosure will be briefly introduced below. Obviously, the accompanying drawings described below are only some embodiments of the present disclosure. For those skilled in the technical field to which the present disclosure belongs, other accompanying drawings can also be obtained based on these accompanying drawings.

FIG. 1 is a first structural schematic diagram of a rotary switch for vehicle of the prior art.

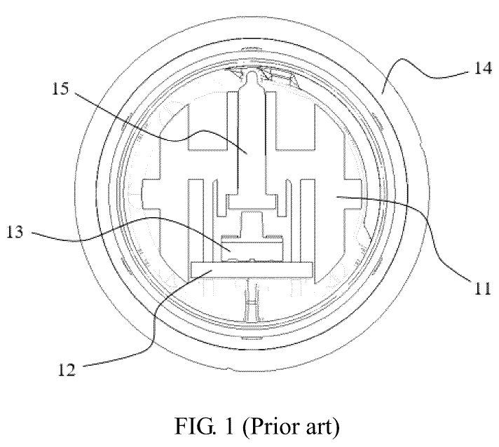

FIG. 2 is a second structural schematic diagram of a rotary switch for vehicle of the prior art.

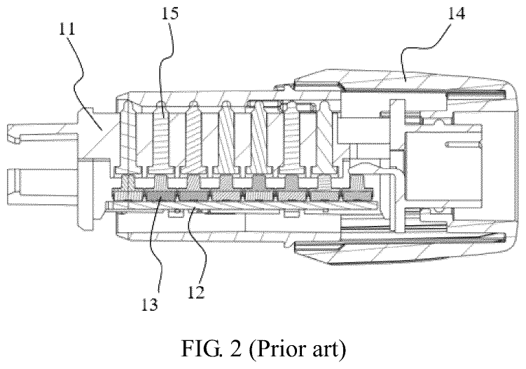

FIG. 3 is an exploded schematic diagram of the rotary switch for vehicle of the present disclosure.

FIG. 4 is a schematic diagram illustrating the assembly of the rotary switch for vehicle of the present disclosure.

FIG. 5 is a schematic diagram of a first application of the rotary switch for vehicle of the present disclosure.

FIG. 6 is a schematic diagram of a second application of the rotary switch for vehicle of the present disclosure.

FIG. 7 is a first cross-sectional schematic diagram of the rotary switch for vehicle of the present disclosure.

FIG. 8 is a structural schematic diagram of a rotary member of a rotary switch for vehicle according to the present disclosure.

FIG. 9 is a second cross-sectional schematic diagram of the rotary switch for vehicle of the present disclosure.

### DETAILED DESCRIPTION OF THE PREFERRED EMBODIMENTS

The advantages, features and technical methods achieved by the present disclosure will be described in more detail with reference to exemplary embodiments and the accompanying drawings so as to be easier to understand. The present disclosure can be implemented in different forms and should not be understood as being limited to the embodiments described herein. On the contrary, for those skilled in the art, the provided embodiments will make the disclosure of the present disclosure more thorough and comprehensive and fully convey the scope of the present disclosure.

It should be understood that when used in the present specification and the appended claims, the term “comprising” indicates the presence of the described features, integrals, steps, operations, elements and/or components, but does not exclude the presence or addition of one or more other features, integrals, steps, operations, elements, components and/or collections thereof. The term “and/or” used in the present specification and the appended claims refers to any combination of one or more of the associated listed items and all possible combinations, and includes those combinations.

It should be understood that although the terms “first”, “second”, etc. may be used in the present disclosure to describe various components, parts, regions, sections, layers and/or parts, these components, parts, regions, sections, layers and/or parts should not be limited by these terms. These terms are only used to distinguish one component, part, region, section, layer and/or part from another component, part, region, section, layer and/or part.

Unless otherwise defined, all terms (including technical and scientific terms) used herein have the same meaning as commonly understood by one of ordinary skill in the art to which the present disclosure belongs. It will be further understood that terms such as those defined in commonly used dictionaries should be interpreted as having definitions consistent with their meanings in the context of the relevant technology and the present disclosure, and will not be interpreted as idealized or overly formal meanings unless explicitly defined in this article.

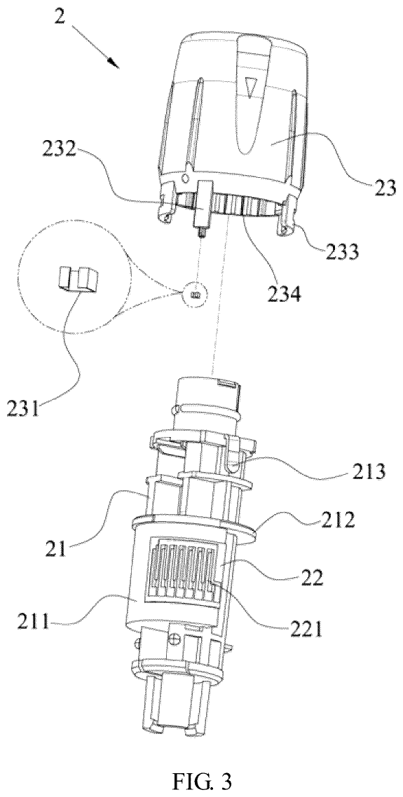

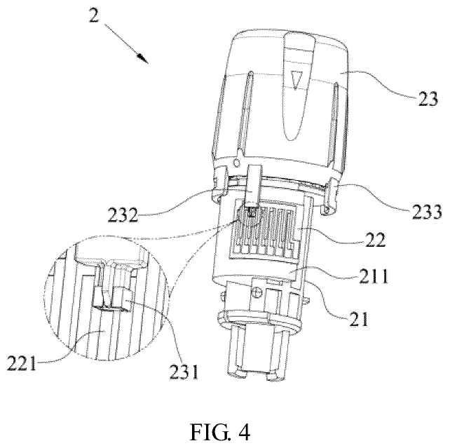

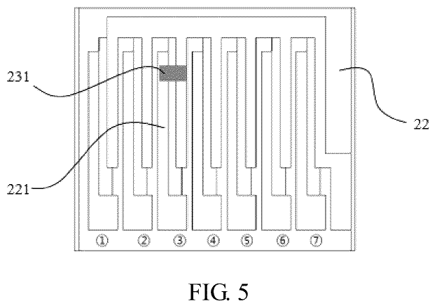

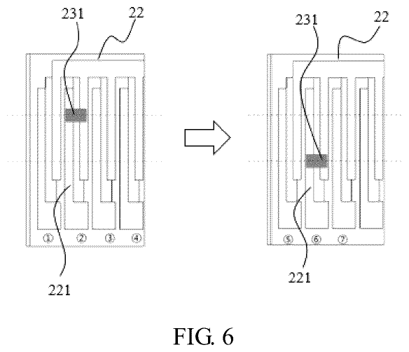

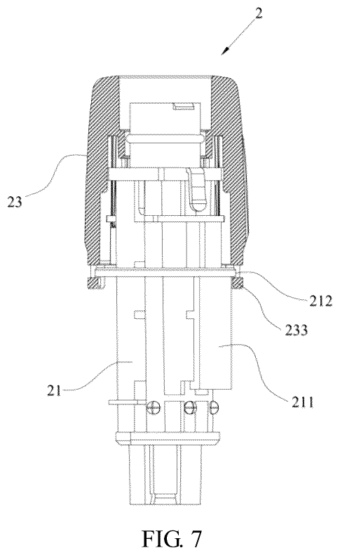

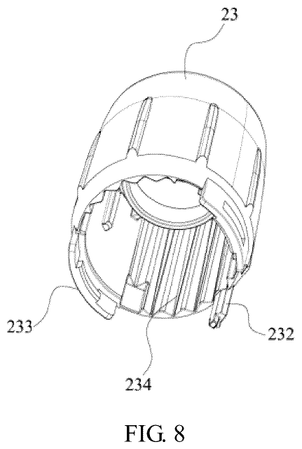

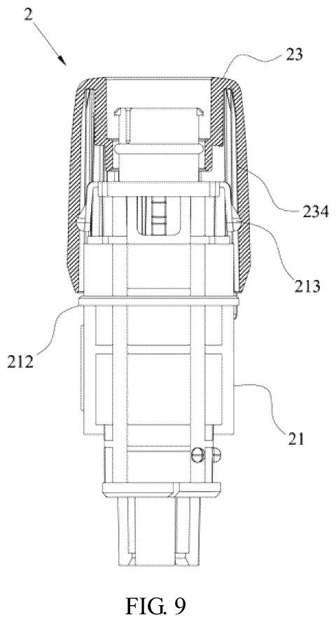

Please refer to FIGS. 3 to 8. FIGS. 3 and 4 are respectively the exploded schematic diagram and the schematic diagram illustrating the assembly of the rotary switch for vehicle of the present disclosure. FIGS. 5 and 6 are respectively the application schematic diagrams of the rotary switch for vehicle of the present disclosure. FIGS. 7 and 9 are respectively the cross-sectional schematic diagrams of the rotary switch for vehicle of the present disclosure at different sections. FIG. 8 is a structural schematic diagram of the rotating member of the rotary switch for vehicle of the present disclosure. The rotary switch for vehicle of the present disclosure is mainly used in the wiper control system, and can also be used in other vehicle control systems or control modules of other electronic devices other than vehicles in different application modes. As shown in the figure, the rotary switch for vehicle 2 of the present disclosure mainly includes a switch body 21, a conductive member 22 and a rotating member 23.

The switch body 21 can be made of plastic or other materials, and is made by injection molding or other processes. One end of the switch body 21 is configured for assembly with the rotating member 23, and the other end can be connected to the vehicle control system, for example, connected or fixed to the wiper lever, and electrically connected to the electronic contact or electronic port in the wiper lever. It is worth mentioning that the outer surface of the switch body 21 is provided with an arc portion 211; preferably, the arc portion 211 is a semicircular arc.

The conductive member 22 may be a flexible printed circuit (FPC). The conductive member 22 is attached to the arc portion 211 and arranged on the outer surface of the switch body 21. The conductive member 22 may be fixed to the outer surface of the switch body 21 by means of adhesive layer, structural fixing, hot melting, welding, etc. The conductive member 22 is electrically connected to the control module 9; wherein the control module 9 is, for example, a control circuit arranged on the switch body 21, or the control module 9 may be a control module or control system in a vehicle, such as a controller area network (CAN or CAN bus), and the conductive member 22 is electrically connected to the controller area network directly or indirectly. It is worth mentioning that the conductive member 22 is provided with a plurality of conductive areas 221 spaced apart along the circumferential direction of the arc portion 211.

The rotating member 23 is rotatably disposed outside the switch body 21. The rotating member 23 is provided with a conductive portion 231 corresponding to the plurality of conductive areas 221, so that when the rotating member 23 is rotated, the conductive portion 231 can conduct one conductive area 221 among the plurality of conductive areas 221; the conductive area 221 is preferably a group of positive and negative electrodes, so that the conductive portion 231 can contact the conductive area 221 to conduct the positive and negative electrodes.

Specifically, the rotating member 23 has an extension arm 232 extending toward the conductive member 22; the conductive portion 231 is disposed at an end of the extension arm 232 away from the main body of the rotating member 23. The conductive portion 231 may be a conductive electroplated layer or a metal body disposed at an end of the extension arm 232; preferably, the conductive portion 231 is a metal sleeve sleeved at an end of the extension arm 232.

During assembly, the relevant personnel only need to fit the conductive member 22 onto the arc portion 211 and then sleeve the rotating member 23 onto the switch body 21 to complete the assembly of the rotary switch for vehicle 2. The assembly is convenient, and fewer parts are used, which can greatly reduce the assembly time and cost.

As shown in FIG. 5, in actual operation, the user can rotate the rotating member 23 so that the conductive portion 231 conducts different conductive areas 221 on the conductive member 22, thereby achieving corresponding control; for example, when the rotary switch for vehicle 2 of the present disclosure is applied to or arranged on a wiper lever, the wiper can be controlled to have different oscillation frequencies by rotating the rotating member 23.

As shown in FIG. 6, in different embodiments, the rotating member 23 may have a displacement along the axial direction relative to the switch body 21, so that when the rotating member 23 is in a first position, the user can achieve, for example, 1 to 4 levels of wiper frequency switching by rotating the rotating member 23, and when the user presses the rotating member 23 or uses the structural configuration (such as the guiding of the inclined surface) to move the rotating member 23 to the second position, the user can achieve, for example, 5 to 7 levels of wiper frequency switching by rotating the rotating member 23. Through this configuration, it is possible to reduce the conductive member 22, and further reduce the cost or reduce the volume of the rotary switch for vehicle 2 of the present disclosure.

As shown in FIG. 7, regarding the manner in which the rotating member 23 is rotatably disposed outside the switch body 21, preferably, the outer surface of the switch body 21 is provided with a lip 212, and the lip 212 is closer to the rotating member 23 than the conductive member 22. The rotating member 23 is provided with two hooking portions 233 corresponding to the lip 212; when the rotating member 23 is sleeved on the switch body 21, the rotating member 23 is assembled to the switch body 21, and the hooking portions 233 are hooked with the lip 212. Through the configuration of the hook portion 233 and the lip 212, the freedom of the rotating member 23 in the axial direction (the axial direction of the switch body 21 or the rotating member 23) can be limited, thereby preventing the rotating member 23 from detaching from the switch body 21 and achieving the function of enabling the rotating member 23 to rotate relative to the switch body 21.

As shown in FIGS. 8 and 9, preferably, the inner surface of the rotating member 23 is provided with at least one wave portion 234; the outer surface of the switch body 21 is provided with at least one elastic protrusion 213 corresponding to the wave portion 234; in this embodiment, the number of the wave portion 234 and the elastic protrusion 213 is two as an exemplary embodiment, and in different embodiments, the wave portion 234 can be one (i.e., a wave portion 234 of a part of the inner circumference range or the wave portion 234 occupies the entire inner circumference), three, four, etc., so the exemplary embodiment should not be considered as a limitation. As such, when the rotating member 23 is assembled to the switch body 21, the elastic protrusion 213 is embedded in one of the grooves of the wave portion 234. By configuring the wave portion 234 and the elastic protrusion 213, it can provide the user with a hand feeling when rotating the rotating member 23 to switch to different sections, so that the user can clearly sense the fixed point of different sections. In other words, the configuration of the crests and troughs of the wave portion 234 corresponds to the configuration of the spaces between the adjacent conductive regions 221.

In summary, the rotary switch for vehicle of the present disclosure can achieve the function of multi-stage switching by configuring the conductive member and the conductive part, thereby greatly reducing or eliminating the use of physical switches (such as push switches), while effectively reducing the cost of parts. In addition, the rotary switch for vehicle of the present disclosure can also reduce the configuration of structural components by configuring the conductive member and the conductive part, thereby achieving the advantages of easy assembly and reducing the overall volume or providing more component placement space.

References to “one embodiment” or “some embodiments” etc. described in the present specification means that one or more embodiments of the present disclosure include specific features, structures or characteristics described in conjunction with the embodiment. Therefore, the statements “in one embodiment”, “in some embodiments”, “in some other embodiments”, “in different embodiments”, etc. that appear in various places in the present specification do not necessarily refer to the same embodiment, but indicates “one or more but not all embodiments”, unless otherwise specifically emphasized. The terms “including”, “comprising”, “having” and their variations all mean “including but not limited to”, unless otherwise specifically emphasized.

The embodiments described herein are only used to illustrate the technical solutions of the present disclosure, rather than to limit the same. Although the present disclosure has been described in detail with reference to the aforementioned embodiments, those skilled in the art should understand that the technical solutions described in the aforementioned embodiments may still be modified, or some of the technical features may be replaced by other equivalents. Such modifications or replacements do not deviate the essence of the corresponding technical solutions from the spirit and scope of the technical solutions of the embodiments of the present application, and should all be included in the scope of the present disclosure.

What is claimed is:

1. A rotary switch for vehicle, comprising:
a switch body is provided with an arc portion on an outer surface of the switch body;
a conductive member attached to the arc portion and disposed on the outer surface of the switch body; the conductive member is electrically connected to a control module, and the conductive member is provided with a plurality of conductive areas spaced apart along a circumferential direction of the arc portion; and
a rotating member rotatably arranged outside the switch body; the rotating member is provided with a conductive part corresponding to the plurality of conductive areas, so that when the rotating member is rotated, the conductive part conducts one of the plurality of conductive areas.

2. The rotary switch for vehicle of claim 1, wherein the arc portion is a semi-arc.

3. The rotary switch for vehicle of claim 1, wherein a lip is provided on the outer surface of the switch body, the lip is closer to the rotating member than the conductive member; the rotating member is provided with two hooking portions facing each other and corresponding to the lip; when the rotating member is assembled to the switch body, the hooking portions are hooked to the lip.

4. The rotary switch for vehicle of claim 1, wherein an inner surface of the rotating member is provided with at least one wave portion; the outer surface of the switch body is provided with at least one elastic protrusion corresponding to the wave portion; when the rotating member is assembled to the switch body, the elastic protrusion is embedded in one of a groove of the wave portion.

5. The rotary switch for vehicle of claim 1, wherein the rotating member is provided with an extension arm extending toward the conductive member; and the conductive portion is disposed at an end of the extension arm away from the rotating member.

6. The rotary switch for vehicle of claim 5, wherein the arc portion is a semi-arc.

7. The rotary switch for vehicle of claim 5, wherein a lip is provided on the outer surface of the switch body, the lip is closer to the rotating member than the conductive member; the rotating member is provided with two hooking portions facing each other and corresponding to the lip; when the rotating member is assembled to the switch body, the hooking portions are hooked to the lip.

8. The rotary switch for vehicle of claim 5, wherein an inner surface of the rotating member is provided with at least one wave portion; the outer surface of the switch body is provided with at least one elastic protrusion corresponding to the wave portion; when the rotating member is assembled to the switch body, the elastic protrusion is embedded in one of a groove of the wave portion.

9. The rotary switch for vehicle of claim 5, wherein the conductive portion is a metal sleeve sleeved on an end of the extension arm.

10. The rotary switch for vehicle of claim 9, wherein the arc portion is a semi-arc.

11. The rotary switch for vehicle of claim 9, wherein a lip is provided on the outer surface of the switch body, the lip is closer to the rotating member than the conductive member; the rotating member is provided with two hooking portions facing each other and corresponding to the lip; when the rotating member is assembled to the switch body, the hooking portions are hooked to the lip.

12. The rotary switch for vehicle of claim 9, wherein an inner surface of the rotating member is provided with at least one wave portion; the outer surface of the switch body is provided with at least one elastic protrusion corresponding to the wave portion; when the rotating member is assembled to the switch body, the elastic protrusion is embedded in one of a groove of the wave portion.
